(19) United States
(12) Patent Application Publication
(10) Pub. No.: US 2004/0152593 A1
(43) Pub. Date: Aug. 5, 2004

(54) Catalyst support

(76) Inventors: Willard A. Cutler, Big Flats, NY (US); Tinghong Tao, Big Flats, NY (US)

Correspondence Address: CORNING INCORPORATED, SP-TI-3-1, CORNING, NY, 14831

(21) Appl. No.: 10/400,742

(22) Filed: Mar. 27, 2003

Related U.S. Application Data
(60) Provisional application No. 60/443,609, filed on Jan. 30, 2003.

(51) Int. Cl. B01J 23/02

(52) U.S. Cl. 502/439; 502/251

(57) ABSTRACT

A catalyst support for use in technologies (i.e., SCR and NOx adsorbers) which address the reduction of NOx from exhaust emissions of diesel and GDI engines. The catalyst support has a honeycomb body composed of a porous ceramic material, and a plurality of parallel cell channels traversing the body from a frontal inlet end to an outlet end thereof. The porous ceramic material is defined by a total porosity greater than 45 vol. %, and a network of interconnected pores with a narrow pore size distribution of pores having a median pore size greater than 5 micrometers but less than 20 micrometers. The catalyst support is capable of attaining higher catalyst loadings without a pressure drop penalty.

This application claims the benefit of U.S. Provisional Application No. 60/443,609, filed Jan. 30, 2003, entitled “Support for Selective Reduction Catalyst”, by Cutler et al.

### BACKGROUND OF INVENTION

The present invention relates to a catalyst support for emission control technologies of nitrogen oxides (NOx) in diesel and gasoline direct injection (GDI) engines. In particular the invention relates to a ceramic catalyst support capable of achieving higher catalyst loadings without a pressure drop and/or mechanical strength penalty.

Diesel and GDI engines are becoming increasingly popular due to the promise of increased fuel efficiency. Similarly to conventional engines, the exhaust gas discharged from diesel and GDI engines needs to be purified of NOx. However, unlike conventional engines which employ three-way catalysts, the diesel and GDI engines cannot employ such catalysts because they produce exhaust gas with an excess amount of oxygen and require conditions where the air-fuel ratio is substantially stoichiometric. Technologies which address NOx reduction in the aforementioned type of engines, are selective catalytic reduction (SCR) and NOx adsorbers.

SCR has been successfully used for the past 20 years in stationary power plants to convert NOx from exhaust gas into nitrogen and water. The same technology now finds employment in mobile diesel engines as an exhaust gas aftertreatment system to help meet impending emission regulations (i.e., Euro IV (2005) and Euro V (2008) in Europe, and Lev 11 (2007) in the USA). In transferring SCR from stationary power plants to mobile diesel engines, however, several factors must be taken into consideration; these include engine exhaust temperature fluctuations, space velocity constraints (limited real estate under vehicle), urea storage and delivery system, sensors and detectors, long term on-vehicle durability and the like. Notwithstanding such obstacles, mobile SCR systems are currently being pursued in the industry.

The SCR system utilizes a reducing agent either dosed into the system or created in-situ, such ammonia or urea (preferred), to react with NOx on a suitable catalyst. Currently, there are three types of SCR catalysts; extruded, impregnated & wrapped and washcoated. Washcoated catalysts are the preferred industry choice. Typically, in such systems a catalyst is coated on an inert support substrate.

NOx adsorbers are similar in that they are made of a support having a catalyst washcoated thereon, and an additional component in the catalyst coating which stores the trapped NOx. The NOx is trapped and stored during lean operation phase of the engine operation and released during the rich phase.

In both technologies the catalyst support is most often formed of cordierite. Washcoated cordierite catalysts offer several advantages, including low cost, high cell density leading to high geometric surface areas, low coefficient of thermal expansion (CTE) and good thermal shock resistance. However, washcoating only provides a limited amount of catalyst per unit substrate volume as is directly related to the thickness of the coating. Increasing the coating layer is one way to increase catalyst loading, however, as a result the pressure drop across the structure increases, which in turn affects fuel efficiency and engine performance.

It would be considered an advancement in the art to obtain a support substrate for use in a SCR catalyst and being capable of attaining higher catalyst loadings without incurring a pressure drop penalty or sacrificing strength. The present invention provides such bodies.

### SUMMARY OF INVENTION

In accordance with the present invention there is provided a novel support for NOx reduction based on washcoating technologies, such as SCR and NOx adsorbers. The support combines high porosity, with an interconnected pore structure, and a narrow pore size distribution, along with a low CTE. As a result the inventive structures allow for higher catalyst loadings than previously possible without a pressure drop penalty, or a loss in the mechanical strength.

Specifically, the inventive catalyst support comprises a honeycomb body composed of a porous ceramic material, and including a plurality of parallel cell channels traversing the body from a frontal inlet end to an outlet end thereof. The honeycomb body has a cell density of 100 cells/in² (15.5 cells/cm²) to 900 cells/in² (141 cells/cm²), preferably 400 cells/in² (62 cells/cm²) to 600 cells/in² (94 cells/cm²), and a wall thickness of 0.004 in. (0.10 mm) to 0.020 in. (0.50 mm).

The porous ceramic material is defined by a total porosity greater than 45 vol. %, preferably greater than 50 vol. %, and more preferably greater than 55 vol. %, and a network of interconnected pores with a narrow pore size distribution of pores having a median pore size greater than 5 micrometers but less than 30 micrometers, preferably less than 20 micrometers, and more preferably less than 15 micrometers. The support is further characterized by a low coefficient of thermal expansion (CTE) at 25-800° C., of less than 15×10⁻⁷/° C., preferably less than 10×10⁻⁷/° C., and more preferably less than 7×10⁻⁷/° C.

The porous ceramic material comprising the catalyst support honeycomb body is selected from the group consisting of titanates, silicates, aluminates, lithium aluminosilicates, carbides, nitrides, borides. In a preferred material the ceramic material is a silicate, more preferably a silicate ceramic predominately composed of a primarily crystalline phase comprising cordierite, and having a composition close to that of Mg₂Al₄Si₅O₁₈.

### DETAILED DESCRIPTION OF INVENTION

The catalyst support in accordance with the present invention is a multicellular ceramic monolith, preferably comprising a honeycomb body having an inlet end and an outlet end, and a multiplicity of cells extending from the inlet end to the outlet end, the cells having porous walls. Suitable honeycomb structures have cellular densities from about 100 cells/in² (15.5 cells/cm²) to about 900 cells/in² (141 cells/cm²), preferably 400 cells/in² (62 cells/cm²) to 600 cells/in² (94 cells/cm²), and wall thickness of 0.004 in. (0.10 mm) to 0.020 in. (0.50 mm).

The catalyst support is further characterized by more open wall porosity for catalyst storage, as well as larger pores to improve catalyst accessibility during catalyst coating processes. Accordingly, a significantly higher catalyst loading can be attained than with commercially available cordierite substrates. Unlike conventional substrates which can only be coated on the walls due to low porosity and small pores, in the present invention the catalyst is loaded into the wall pores of the inventive supports. This not only provides for more catalyst per unit substrate volume, but also no pressure drop or mechanical strength penalty, and minimal impact on CTE in the resulting structure.

Accordingly, the total porosity is greater than 45 vol. %, preferably greater than 50 vol. %, and more preferably greater than 55 vol. %. The porosity is uniquely comprised of a network of interconnected pores with a narrow pore size distribution of pores having a median pore size greater than 5 micrometers but less than 30 micrometers, preferably less than 20 micrometers, and more preferably less than 15 micrometers. By narrow pore size distribution is meant that more than 85% of the total porosity has a median pore size of greater than 5 micrometers and less than 30 micrometers, preferably less than 20 micrometers, and more preferably less than 15 micrometers.

Good pore connectivity and narrow pore size distribution promote a low pressure drop regardless of the higher catalyst loadings. Also, a narrow pore size distribution is conducive to high mechanical strength. Strength is particularly important for structures with very thin webs (<0.008 in), and is inversely proportional to the radius of the largest pore, and therefore by modifying the large end of the pore size distribution the strength in the resulting product is greatly benefited.

Another advantage of the present invention is a low thermal expansion resulting in excellent thermal shock resistance (TSR). TSR is inversely proportional to the coefficient of thermal expansion (CTE). That is, honeycomb structures with low thermal expansion have good thermal shock resistance and can survive the wide temperature fluctuations that are encountered in application. Accordingly, the coated CTE from 22° to 800° C., as measured by dilatometry, is less than 15×10⁻⁷/° C., preferably less than 10×10⁻⁷/° C., and more preferably less than 7×10⁻⁷/° C.

The invention is especially suited for catalyst supports comprising ceramic materials such as titanates, silicates, aluminates, lithium aluminosilicates, carbides, nitrides, borides, as well as others. In particular, ceramic materials comprising silicon carbide, aluminum titanate, calcium aluminate, and the like. In a particularly preferred embodiment, the present invention is especially suitable for ceramic materials, such as those that yield cordierite, mullite, or mixtures of these on firing. Some examples of such mixtures are about 2-60% mullite, and about 30-96% cordierite, with allowance for other phases, typically up to about 10% by weight.

In order to obtain a cordierite body possessing the unique combination of properties described above it is necessary to utilize specific combinations of cordierite-forming raw materials in the batch mixture. Some batch mixture compositions that are especially suited to the practice of the present invention are those disclosed in co-pending, co-assigned U.S. patent application entitled “Magnesium Aluminum Silicate Structures for DPF Applications” by Beall et al., having serial No. 60/392,699, herein incorporated by referenced in its entirety. A particularly preferred batch composition consists essentially of 12 to 16% by weight magnesium oxide, 35 to 41% by weight alumina, and 43 to 53% by weight silica.

Other batch mixture compositions that are especially suited to the practice of the present invention are those disclosed in co-pending, co-assigned U.S. patent application entitled “Cordierite Ceramic Body and Method” by Gregory A. Merkel, having Ser. No. 10/354,326, herein incorporated by reference in its entirety. A particularly preferred batch composition consists essentially of 11 to 23% by weight silica, 28 to 40% by weight alumina, 39 to 42% by weight percent fine talc having a median particle diameter, as measured by laser diffraction, of less than 10 micrometers, preferably less than 7 micrometers, and more preferably less than 5 micrometers, and a B.E.T. specific surface area of greater than 5 m²/g, preferably greater than 8 m²/g. and 20 to 40 percent graphite as the pore former having a median particle diameter of between 15 and 50 micrometers, and optionally 8 to 17% by weight kaolin.

The batch composition could further include a pore former to better control the porosity and/or pore size, that is preferably a particulate material selected from the group consisting of graphite, cellulose, starch, synthetic polymers such as polyacrylates and polyethylenes, and combinations thereof. The weight percent of the pore former is computed as: 100×[weight of pore former/weight of cordierite-forming raw materials]. Preferably the pore former is added at 5 to 40 weight percent. Graphite and potato starch are preferred pore formers for purposes of the present invention. The median particle diameter of the pore former is at least 3 micrometers and not more than 200 micrometers, preferably at least 5 micrometers and not more than 1500 micrometers, and more preferably at least 10 micrometers and not more than 100 micrometers.

As it will be recognized by those skilled in the art, ceramic batches of the type described above are intimately blended with a vehicle and forming aids which impart plastic formability and green strength to the raw materials when they are shaped into a body. Forming is by any known method for shaping plastic mixtures, but preferably by extrusion which is well known in the art. Extrusion aids are used, most typically methyl cellulose which serves as a binder, and sodium stearate, which serves as a lubricant. The relative amounts of forming aids can vary depending on factors such as the nature and amounts of raw materials used, and the like. For example, the typical amounts of forming aids are about 2% to about 10% by weight of methyl cellulose, and preferably about 3% to about 6% by weight, and about 0.3% to about 2% by weight sodium stearate, and preferably about 0.6% by weight.

The aforementioned components are mixed together in dry form, and then with water as the vehicle. The amount of water can vary from one batch of materials to another and therefore is determined by pre-testing the particular batch for extrudability. The resulting plastic mixture is forced through a die to form a multicellular structure, preferably a honeycomb structure having a plurality of parallel cell channels traversing the body from a frontal inlet end to an outlet end thereof. The green honeycomb bodies are dried, and then fired at a sufficient temperature and for a sufficient time to form the final cordierite (Mg₂Al₄Si₅O₁₈) product structure. Typically, firing is done by heating to a maximum temperature of about 1405° C. to 1430° C., over a time period of 50 to 300 hours, with a hold at top temperature of 5 to 25 hours. The resulting honeycomb structures are ready for coating with a catalyst and use in SCR systems.

To more fully illustrate the invention, the following non-limiting examples are presented below. All parts, portion and percentages are on a weight basis unless otherwise stated.

### EXAMPLES

Batch mixtures, as listed in percent by weight, suitable for the formation of cordierite structures, are listed in TABLE II. TABLE I provides particle size information on the raw materials. Particle sizes were obtained via laser diffraction unless otherwise stated. Examples were prepared by mixing together 100 parts by weight of the dry ingredients (oxides plus pore formers) with about 4 to 6 parts by weight methyl cellulose and 1 part by weight sodium stearate. Example 4 additionally includes about 1 part by stearic acid, and 10 parts by weight polyalphyl olefin.

The dry mixtures were then plasticized with about 25 to 45 parts by weight deionized water and extruded into honeycomb having a nominal cell density of 200 cells/inch² and a wall thickness of 0.012 inches. The honeycombs were dried, and subsequently fired to a temperature of 1405 to 1415° C. (examples 1-3), 1425° C. (example 4), and 1430° C. (example 5), held at that temperature for 10 to 25 hours, and then cooled to room temperature.

Properties provided include the percent porosity, in volume percent, and median pore size, both as measured by mercury porosimetry, the mean or average coefficient of thermal expansion (CTE) as measured by dilatometry over a temperature of 25 to 800° C., and the modulus of rupture strength (MOR) in psi as measured by a four-point method on bars.

An examination of TABLE II reveals that the examples provided possess the claimed porosity of between about 49 and 61 vol. %, and median pore size of between about 7 and 14 micrometers. Furthermore the examples exhibit a low CTE of between about 4 and 13×10⁻⁷/° C.

It should be understood that while the present invention has been described in detail with respect to certain illustrative and specific embodiments thereof, it should not be considered limited to such, as numerous modifications are possible without departing from the broad spirit and scope of the present invention as defined by the appended claims.

TABLE I
Raw Materials

| Raw Material | Median Particle Diameter (μm) |
|---|---|
| Talc | 4.9 |
| Magnesium Oxide | 1.0* |
| Alumina I | 6.8 |
| Alumina III | 5.6-7.0* |
| Alumina IV | 1.8-3.5* |
| Aluminum Hydroxide | 5.0 |
| Dispersable Boehmite | — |
| Silica I | 23 |
| Silica II | 4.6 |
| Graphite I (spherical) | 29 |
| Graphite II | 36 |
| Corn Starch | 15 |

*As measured by Sedigraph analysis.

TABLE II
Compositions and Properties

| | Example Number | | | | |
|---|---|---|---|---|---|
| | 1 | 2 | 3 | 4 | 5 |
| Talc | 39.96 | 39.96 | 39.86 | | |
| Alumina I | 21.54 | 21.54 | 19.05 | | |
| Alumina II | | | | | |
| Alumina III | | | | 28.9 | 35.0 |
| Aluminum Hydroxide | 16.35 | 16.35 | 14.01 | | |
| Dispersable Boehmite | | | 4.99 | | |
| Magnesium Oxide | | | | 10.3 | 14.0 |
| Silica I | 22.15 | 22.15 | 22.09 | | |
| Silica II | | | | 50.7 | 51.0 |
| Graphite I | 25.00 | 40.00 | | | |
| Graphite II | | | 30.00 | | |
| Corn Starch | | | | | 10.0 |
| % Porosity | 54.7 | 61.3 | 54.3 | 52.9 | 49.0 |
| Median Pore Size (μm) | 12.1 | 13.8 | 10.4 | 7.3 | 8.6 |
| CTE, 25-800° C. (10⁻⁷/° C.) | 5.1 | 5.9 | 4.3 | 12.7 | 5.75 |
| 4-Point MOR (psi) | — | — | — | 2044 | — |

What is claimed:

1. A catalyst support comprising a honeycomb body composed of a porous ceramic material, and including a plurality of parallel cell channels traversing the body from a frontal inlet end to an outlet end thereof:
wherein the porous ceramic material is defined by a total porosity greater than 45 vol. %, and a network of interconnected pores with a narrow pore size distribution of pores having a median pore size greater than 5 micrometers but less than 30 micrometers,
whereby a higher catalyst loading can be achieved on the support substrate, without a pressure drop penalty.

2. The catalyst support of claim 1 wherein the porous ceramic material has total porosity greater than 50 vol. %, and a network of interconnected pores with a narrow pore size distribution of pores having a median pore size greater than 5 micrometers but less than 20 micrometers.

3. The catalyst support of claim 2 wherein the porous ceramic material has total porosity greater than 55 vol. %, and a network of interconnected pores with a narrow pore size distribution of pores having a median pore size greater than 5 micrometers but less than 15 micrometers.

4. The catalyst support of claim 1 further having a mean coefficient of thermal expansion at 25-800° C. of less than 15×10⁻⁷/° C.

5. The catalyst support of claim 4 wherein the mean coefficient of thermal expansion at 25-800° C. of less than 10×10⁻⁷/° C.

6. The catalyst support of claim 5 wherein the mean coefficient of thermal expansion at 25-800° C. of less than 7×10⁻⁷/° C.

7. The catalyst support of claim 1 wherein the ceramic material is selected from the group consisting of titanates, silicates, aluminates, lithium aluminosilicates, carbides, nitrides, borides.

8. The catalyst support of claim 7 wherein the ceramic material is a silicate.

9. The catalyst support of claim 8 wherein the ceramic material is a silicate approximating the stoichiometry Mg₂Al₄Si₅O₁₈.

10. A cordierite substrate for use as a support of SCR and NOx adsorber catalysts, and having a mean coefficient of thermal expansion at 25-800° C. of less than 15×10⁻⁷/° C., a total porosity greater than 45 vol. %, and a network of interconnected pores with a narrow pore size distribution of pores having a median pore size greater than 5 micrometers but less than 20 micrometers.

11. The cordierite substrate of claim 10 wherein the mean coefficient of thermal expansion at 25-800° C. of less than 10×10⁻⁷/° C.

12. The cordierite substrate of claim 11 wherein the mean coefficient of thermal expansion at 25-800° C. of less than 7×10⁻⁷/° C.

13. The cordierite substrate of claim 10 wherein the porous ceramic material has total porosity greater than 50 vol. %, and a network of interconnected pores with a narrow pore size distribution of pores having a median pore size greater than 5 micrometers but less than 15 micrometers.

14. The cordierite substrate of claim 13 wherein the porous ceramic material has total porosity greater than 55 vol. %, and a network of interconnected pores with a narrow pore size distribution of pores having a median pore size greater than 5 micrometers but less than 15 micrometers.

15. The cordierite substrate of claim 10 having a honeycomb body having a frontal inlet end and an outlet end, and a plurality of parallel cell channels extending therebetween.

16. The cordierite substrate of claim 15 having a cell density of 100 cells/in² (15.5 cells/cm²) to 900 cells/in² (141 cells/cm²).

17. The cordierite substrate of claim 16 wherein the cell density is 400 cells/in (62 cells/cm²) to 600 cells/in² (94 cells/cm²).

18. The cordierite substrate of claim 17 having a wall thickness of 0.004 in. (0.10 mm) to 0.020 in. (0.50 mm).
